(19) United States
(12) Patent Application Publication
(10) Pub. No.: US 2007/0137025 A1
(43) Pub. Date: Jun. 21, 2007

(54) Method of bonding flying leads

(75) Inventors: Takashi Kubota, Kawasaki (JP); Kenji Kobae, Kawasaki (JP); Kimio Nakamura, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJITSU LIMITED, Kawasaki (JP)

(21) Appl. No.: 11/359,427

(22) Filed: Feb. 23, 2006

(30) Foreign Application Priority Data
Dec. 20, 2005 (JP) 2005-366342

(51) Int. Cl. B23K 1/06

(52) U.S. Cl. 29/603.04; 29/603.06; 360/245.9; 360/244.3; 156/73.1; 228/1.1

(57) ABSTRACT

The method of bonding flying leads is capable of efficiently supersonic-bonding the flying leads to pads of a board and improving bonding reliability therebetween. The method comprises the steps of: positioning the flying leads to correspond to the pads arranged parallel; and applying supersonic vibrations to a bonding tool so as to respectively bond the flying leads to the pads. And widths of the flying leads are wider than those of the pads, and supersonic vibrations are applied to the bonding tool, which is pressing the flying leads onto the pads, so that the flying leads are respectively supersonic-bonded to the pads.

### BACKGROUND OF THE INVENTION

The present invention relates to a method of bonding flying leads, more precisely relates to a method of bonding flying leads to pads of a board by using supersonic vibrations.

A carriage assembly of a magnetic disk drive unit is shown in FIG. 8. The carriage assembly includes a plurality of carriage arms 10, whose number corresponds to that of magnetic disks, and suspensions 12, on which magnetic heads are mounted, are attached to front ends of the carriage arms 10. Base ends of the carriage arms 10 are attached to an actuator shaft 14, and the carriage arms 10 are turned about the shaft 14 and moved parallel to surfaces of the magnetic disks.

The magnetic heads mounted on the suspensions 12 are electrically connected to a signal transmission circuit by several manners. FIG. 8 shows a connecting structure using a so-called long tail suspension board, wherein an end of a suspension board of the suspension 12 is extended to a location of attaching a flexible board 16, which is attached to side faces of the base ends of the carriage arms 10.

In the connecting structure using the long tail suspension board, pads of the flexible board 16 and the flying leads 18 (see FIG. 9) of the long suspension board are correctly positioned, then the flying leads 18 are bonded to the pads by a supersonic bonding tool. In FIG. 9, the flying leads 18 are supersonic-bonded to the pads 17 of the flexible board 16 by the bonding tool 20.

The supersonic bonding method has been used for bonding a semiconductor chip to a circuit board by flip-chip connection, bonding wires to leads, etc. To securely perform the supersonic bonding, several ideas have been proposed. For example, Japanese Patent Gazette No. 10-150137 discloses a method of bonding wires, wherein a leadframe is pressed by a vibration restraining member so as to prevent resonance of the leadframe; Japanese Patent Gazette No. 2005-136399 discloses a method of forming bonding-electrodes, wherein an electrically conductive material is applied to electrodes of a circuit board so as to broaden a bonding area; Japanese Patent Gazettes No. 08-146451 and No. 10-189657 disclose methods of bonding two members, wherein an anisotropic conductive film is provided between the members, and supersonic waves are applied in the direction for mutual contact; Japanese Patent Gazette No. 05-63038 discloses a method of bonding two members, wherein their bonding faces are made rough; and Japanese Patent Gazette No. 2005-93581 discloses a method of bonding two members, wherein non-conductive adhesive is applied to bonding faces.

In the connecting structure using the long tail suspension board shown in FIG. 8, a plurality of the flying leads 18 are arranged parallel with minute separations. The flying leads 18 may be supersonic-bonded, one by one, to the pads 17, but it is efficient to simultaneously supersonic-bond a plurality of the flying leads 18 as shown in FIG. 9.

In FIG. 9, the bonding tool 20 contacts and bonds two flying leads 18. However, in case that the bonding tool 20 contacts a plurality of the flying leads 18, a working face of the bonding tool 20 is a flat face. So, if asperities exist in the bonding face, bonding strength differs at every bonding point, so that bonding reliability must be lowered.

FIG. 10 is a sectional view of the flying lead 18 and the pad 17, which have been mutually bonded. The boundary includes three kinds of parts: (1) completely bonded parts, wherein projections are crushed and oxide film is broken, so that the bonding faces are actually bonded each other; (2) poorly bonded parts, wherein the oxide film exists between the bonding faces; and (3) nonbonded parts “A”, wherein the bonding faces are not bonded each other.

Outer surfaces of the flying leads 18 and the pads 17 are gold-plated, so that they are connected by gold-gold bonding. The gold plated layers are capable of absorbing the asperities formed in the bonding faces of the flying leads 18 and the pads 17. However, thickness of the gold layers are about 3 μm, so all of the asperities cannot be fully absorbed.

### SUMMARY OF THE INVENTION

The present invention was conceived to solve the above described problems.

An object of the present invention is to provide a method of bonding flying leads, which is capable of efficiently supersonic-bonding the flying leads to pads of a board and improving bonding reliability therebetween.

To achieve the object, a first method of bonding flying leads to pads of a board comprises the steps of: positioning the flying leads to correspond to the pads arranged parallel; and applying supersonic vibrations to a bonding tool so as to respectively bond the flying leads to the pads, wherein widths of the flying leads are wider than those of the pads, and supersonic vibrations are applied to the bonding tool, which is pressing the flying leads onto the pads, so that the flying leads are respectively supersonic-bonded to the pads.

With this method, the widths of the flying leads are made wider than those of the pads, so edges of the pads bite the flying leads when the bonding tool supersonic-bonds the flying leads to the pads. Therefore, the flying leads can be securely supersonic-bonded to the pads.

A second method comprises the steps of: positioning the flying leads to correspond to the pads arranged parallel; and applying supersonic vibrations to a bonding tool so as to respectively bond the flying leads to the pads, wherein one side face of each flying lead, which is pressed by the bonding tool, is coated with an insulating layer, and supersonic vibrations are applied to the bonding tool, which is pressing the flying leads onto the pads through the insulating layers, so that the flying leads are respectively supersonic-bonded to the pads.

With this method, the insulating layers, which are formed on the one side faces of the flying leads, act as buffer layers capable of absorbing variation of thickness of the pads and asperities in bonding faces. Therefore, the supersonic bonding can be securely performed.

A third method comprises the steps of: positioning the flying leads to correspond to the pads arranged parallel; and applying supersonic vibrations to a bonding tool so as to respectively bond the flying leads to the pads, wherein an end section of each flying lead is folded in the thickness direction, and supersonic vibrations are applied to the bonding tool, which is pressing the folded flying leads, in the thickness direction, onto the pads, so that the flying leads are respectively supersonic-bonded to the pads.

With this method, the folded end sections of the flying leads have elasticity, so they are capable of absorbing variation of thickness of the pads and asperities in bonding faces. Therefore, the supersonic bonding can be securely performed.

A fourth method comprises the steps of: positioning the flying leads to correspond to the pads arranged parallel; and applying supersonic vibrations to a bonding tool so as to respectively bond the flying leads to the pads, wherein each flying lead is coated with a plated layer and has an elliptic cross-sectional shape, and supersonic vibrations are applied to the bonding tool, which is pressing the flying leads onto the pads, so that the flying leads are respectively supersonic-bonded to the pads.

With this method, the plated layers have the elliptic cross-sectional shapes, so the plated layers are crushed when the supersonic bonding is performed. Thus, the crushed plated layers are capable of absorbing variation of thickness of the pads and asperities in bonding faces, and the supersonic bonding can be securely performed.

By employing the methods of the present invention, variation of thickness of the pads and asperities in bonding faces can be absorbed, so that the flying leads can be securely supersonic-bonded to the pads.

### BRIEF DESCRIPTION OF THE DRAWINGS

Embodiments of the present invention will now be described by way of examples and with reference to the accompanying drawings, in which:

FIGS. 1A and 1B are explanation views showing the method of a first embodiment, wherein flying leads are supersonic-bonded to pads by a bonding tool;

FIG. 2A is a sectional view of the flying lead used in a second embodiment;

FIG. 2B is a sectional view of the conventional flying lead;

FIG. 3 is an explanation view showing the method of the second embodiment, wherein the flying leads are supersonic-bonded to the pads by the bonding tool;

FIG. 4 is a side view of the flying lead used in a third embodiment;

FIG. 5 is an explanation view showing the method of the third embodiment, wherein the flying leads are supersonic-bonded to the pads by the bonding tool;

FIG. 6 is a sectional view of the flying lead, which is used in a fourth embodiment, seen from an end;

FIG. 7 is an explanation view showing the method of the fourth embodiment, wherein the flying leads are supersonic-bonded to the pads by the bonding tool;

FIG. 8 is a perspective view of the conventional carriage assembly having the long tail suspension board;

FIG. 9 is an explanation view showing the conventional method of bonding the flying leads to the pads; and

FIG. 10 is a sectional view of the boundary of the flying lead and the pad, which are mutually bonded.

### DETAILED DESCRIPTION OF THE EMBODIMENTS

Preferred embodiments of the present invention will now be described in detail with reference to the accompanying drawings.

In the following embodiments, flying leads 18, which are formed in a long tail suspension board, are bonded to a flexible board 16 when a carriage assembly is assembled.

### First Embodiment

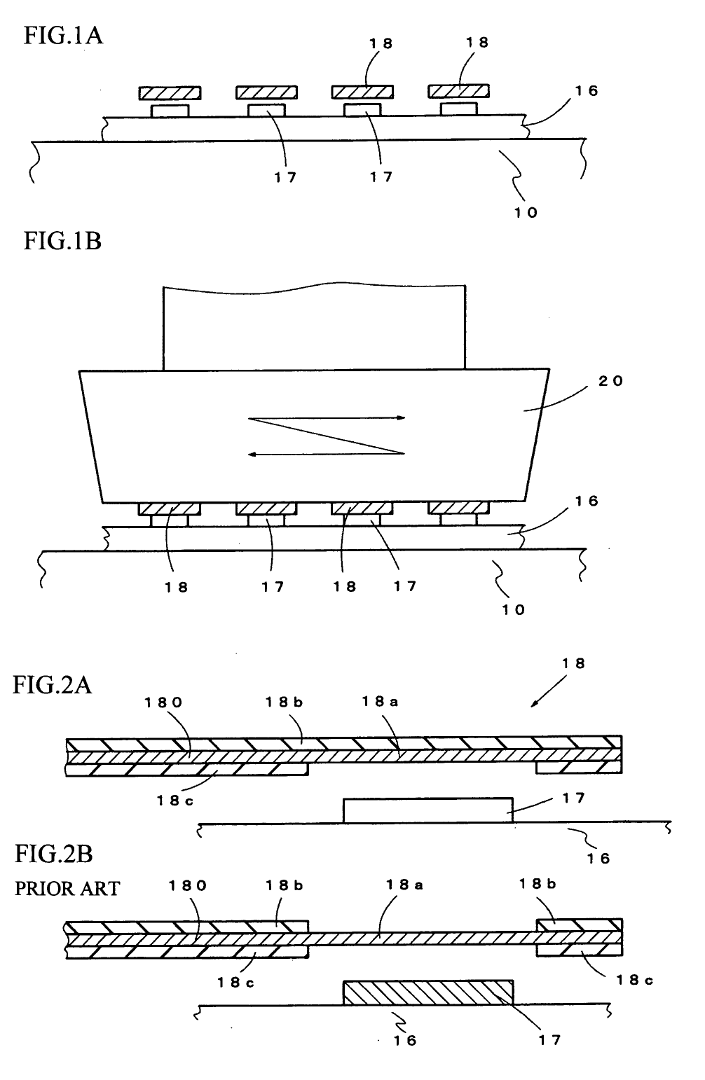

A first embodiment of the present invention will be explained with reference to FIGS. 1A and 1B.

In FIG. 1A, the flying leads 18 of the long tail suspension board is positioned to correspond to the flexible board 16, which is attached to an carriage arm 10. The flying leads 18 respectively correspond to pads 17 of the flexible board 16.

In the present embodiment, width of each pad 17, which is exposed in a surface of the flexible board 16, is narrower than that of each flying lead 18, and both side edges of each flying lead 18 locate on the outer sides of both edges of each pad 17 when the flying leads 18 are positioned to respectively correspond to the pads 17.

The flying leads 18 are arranged parallel to correspond to the pads 17, which are arranged parallel at regular intervals in the flexible board 16. Surfaces of the pads 17 and the flying leads 18 are plated with gold.

In FIG. 1B, a bonding tool 20 presses the flying leads 18, and supersonic vibrations are applied to the bonding tool 20 so as to supersonic-bond the flying leads 18 to the pads 17.

In the present embodiment, the width of each flying lead 18 is wider than that of each pad 17, so the both edges of each pad 17 bite a bonding face (bottom face) of each flying lead 18 when the supersonic vibrations are applied to the flying lead 18 via the bonding tool 20. Therefore, the flying leads 18 can be securely bonded to the pads 17.

Since the both edges of each pad 17 bite the bonding face of each flying lead 18, the flying leads 18 can be securely bonded to the pads 17 even if flatness of the pads 17 are irregular. Irregularity of the flatness and thickness of the pads 17 can be absorbed, so that secure super sonic bonding can be performed. Even if the bonding tool 20, whose bottom working face is flat, simultaneously presses a plurality of the flying leads 18 onto the pads 17, the super sonic bonding can be securely performed.

In the present embodiment, the biting function of the edges of the pads 17 is used for the supersonic bonding. Thus, the flying leads 18 can be further securely bonded to the pads 17 by increasing rigidity of the pads 17. The pads 17 and cable patterns of the flexible board 16 are simultaneously formed by etching a electrically conductive layer, e.g., copper layer, formed on a surface of the flexible board 16. After exposing the pads 17 made of the copper layer, a rigid layer, e.g., nickel plated layer, is formed as a base layer, then the base layer is plated with gold, so that the rigidity of the pads 17 can be increased.

### Second Embodiment

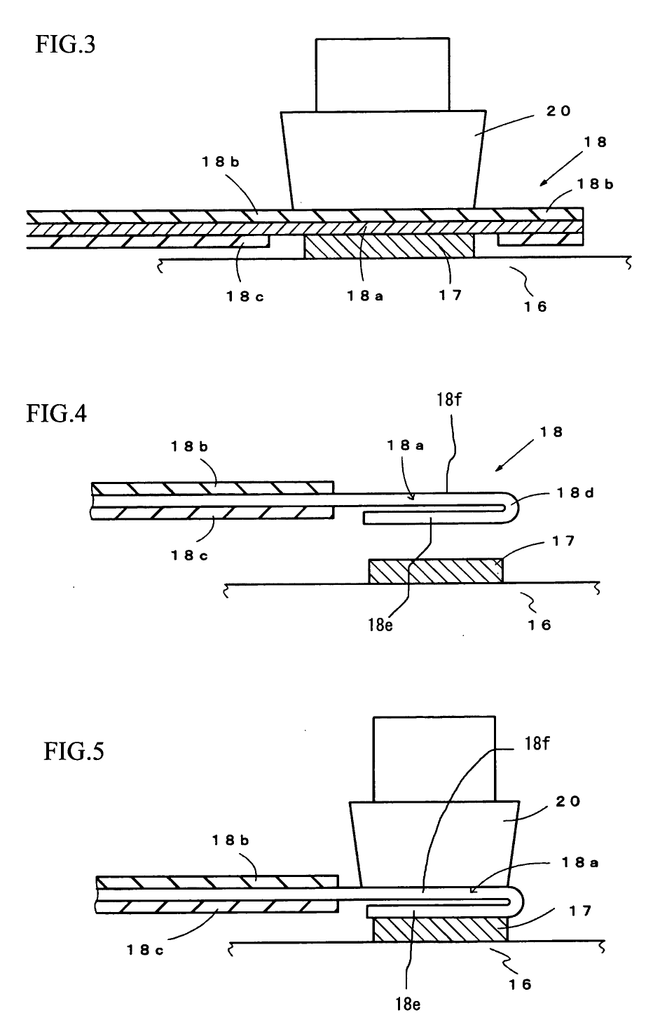

A second embodiment of the present invention will be explained with reference to FIGS. 2A, 2B and 3.

FIG. 2B shows a structure of the conventional flying lead 18. The pad 17 and the flying lead 18 are seen from a side or in the width direction. In the conventional flying lead 18, both sides of a conductive section 180 of the flying lead 18 are covered with insulating layers 18b and 18c, e.g., polyimide films, and a conductive lead section 18a, which correspond to the pad 17, is not covered with the insulating layers 18b and 18c, so that both side faces of the conductive lead section 18a, which strides over the pad 17 in the longitudinal direction, are exposed.

FIG. 2A shows a structure of the flying lead 18 of the present embodiment. An upper side face of the flying lead 18, which will be pressed by the bonding tool 20 for the supersonic boding, is entirely covered with the insulating layer 18b; a lower side face of the conductive lead section 18a, which corresponds to the bonding face of the pad 17, is not covered with the insulating layer 18c. Namely, the lower side face is exposed.

In FIG. 3, the flying lead 18 of the present embodiment (see FIG. 2A) is supersonic-bonded to the pad 17 by the bonding tool 20. Since the upper side face of the flying lead 18, which contacts the working face of the bonding tool 20, is covered with the insulating layer 18b, the insulating layer 18b located between the bonding tool 20 and the conductive lead section 18a acts as a buffer when the bonding tool 20 presses the flying lead 18 onto the pad 17 with applying supersonic vibrations. Even if flatness of the bonding faces of the pads 17 and the flying leads 18 and thickness of the pads 17 and the lead sections 18a are varied, the variations can be absorbed so that the flying leads 18 can be securely bonded to the pads 17. The surfaces of the pads 17 and the exposed faces of the lead sections 18a are plated with gold, so the lead sections 18a are gold-gold-bonded to the pads 17.

### Third Embodiment

A third embodiment of the present invention will be explained with reference to FIGS. 4 and 5.

In FIG. 4, the flying lead 18 to be bonded to the pad 17 is seen from the side. In the present embodiment, the lead section 18a, which is extended from the end of the long tail suspension board, is folded to form into a U-shape. A symbol 18d stands for a folded section, and a lower side part 18e and an upper side part 18f of the lead section 18a are mutually faced. A length of the lower side part 18e of the lead section 18a is almost equal to that of the pad 17. A small clearance is formed between the lower side part 18e and the upper side part 18f, so that the folded section 18d has spring function.

In FIG. 5, the U-shaped flying lead 18 is positioned to correspond to the pad 17, and the bonding tool 20 presses the flying lead 18 downward. Simultaneously, supersonic vibrations are applied to the bonding tool 20 so as to supersonic-bond the flying lead 18 to the pad 17.

As shown in the drawing, the lower side part 18e and the upper side part 18f of the flying lead 18 are clamped between the bonding tool 20 and the pad 17, so the spring function of the folded section 18d works. As described above, the folded section 18d has the spring function. So, even if flatness of the bonding faces of the pads 17 and the flying leads 18 are varied, the variations can be absorbed so that the flying leads 18 can be securely bonded to the pads 17.

### Fourth Embodiment

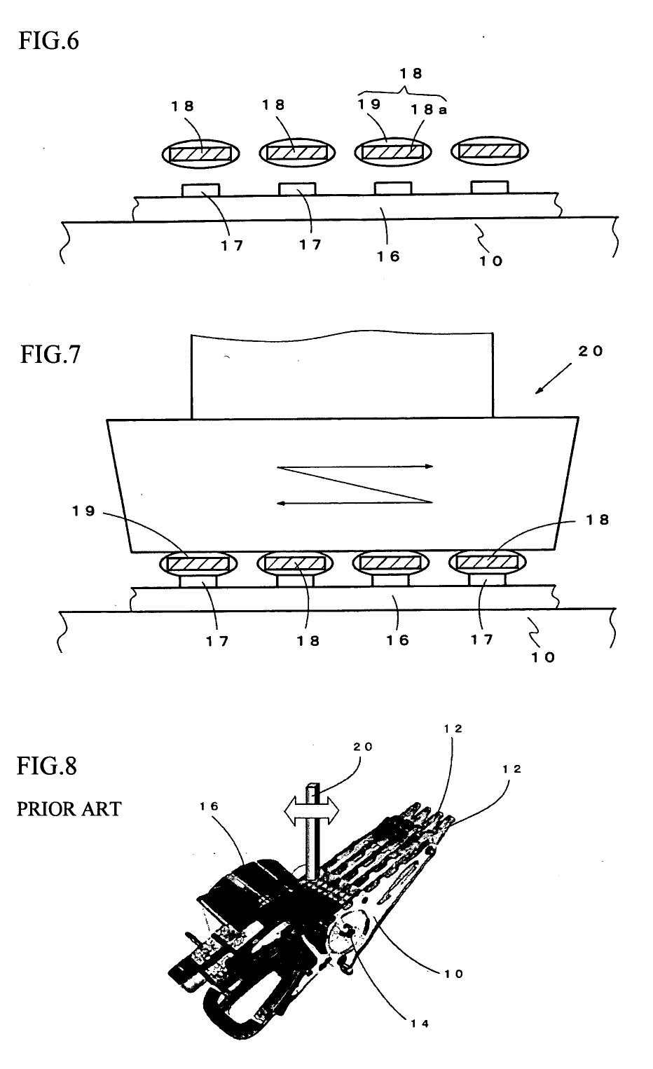

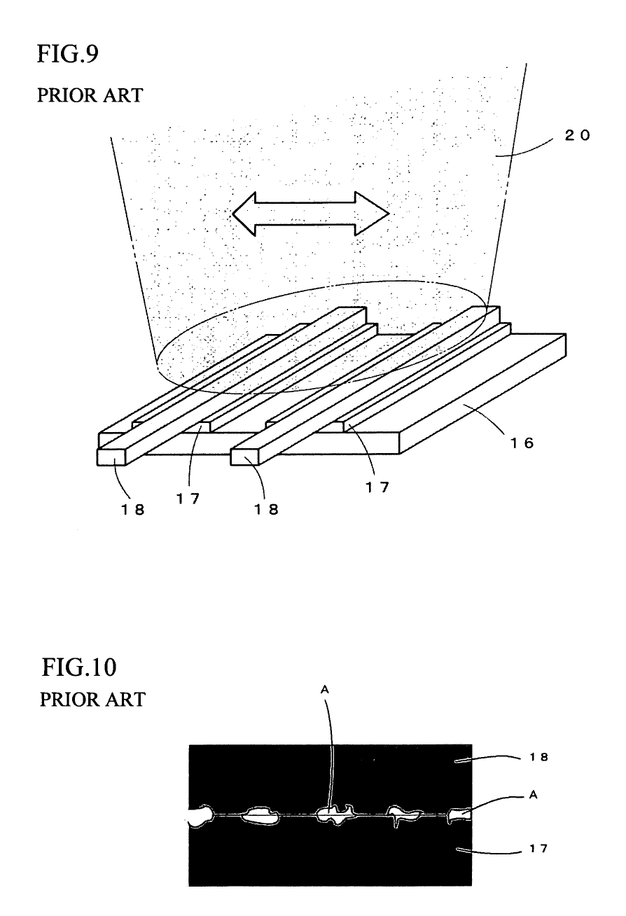

A fourth embodiment of the present invention will be explained with reference to FIGS. 6 and 7.

FIG. 6 is a sectional view of the flying leads 18 to be bonded to the pads 17 seen from longitudinal ends. In the present embodiment, the lead section 18a of each flying lead 18 is coated with a gold plated layer 19, and it has an elliptic cross-sectional shape. In FIG. 6, the flying leads 18 are positioned above the pads 17 and respectively corresponded to the pads 17.

In FIG. 7, the bonding tool 20 presses a plurality of the flying leads 18 downward. Simultaneously, supersonic vibrations are applied to the bonding tool 20 so as to supersonic-bond the flying leads 18 to the pads 17.

By forming the cross-sectional shape of each flying lead 18 coated with the gold plated layer 19 into the elliptical shape, a transverse center part of each flying lead 18, which is the thickest projected part in section, contacts the bonding tool 20 and the pad 17 when the bonding tool 20 presses each flying lead 18 onto each pad 17. Further, by gradually increasing a pressing force of the bonding tool 20 with applying supersonic vibrations to each flying lead 18, the gold plated layer 19 of each projected parts is gradually crushed so that the flying lead 18 and the pad 17 are bonded with gradually broadening the boding area therebetween.

By forming the cross-sectional shape of each lead section 18a coated with the gold plated layer 19 into the elliptical shape, the bonding tool 20 securely presses and crushes each flying lead 18. Even if flatness of the bonding faces of the pads 17 and the flying leads 18 and thickness of the pads 17 and the lead sections 18a are varied, the variations can be absorbed so that the flying leads 18 can be securely bonded to the pads 17.

Note that, in the above described embodiments, the flying leads 18 of the long tail suspension board are supersonic-bonded to the pads 17 of the flexible board 16 in the assembling step of the carriage assembly. However, the present invention is not limited to the above described embodiments. For example, the method of the present invention may be applied for supersonic-bonding flying leads to pads of a circuit board. A plurality of the flying leads need not be bonded simultaneously. The flying leads may be bonded to the pads one by one.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of bonding flying leads to pads of a board,
comprising the steps of:
positioning the flying leads to correspond to the pads arranged parallel; and
applying supersonic vibrations to a bonding tool so as to respectively bond the flying leads to the pads,
wherein widths of the flying leads are wider than those of the pads, and
supersonic vibrations are applied to the bonding tool, which is pressing the flying leads onto the pads, so that the flying leads are respectively supersonic-bonded to the pads.

2. A method of bonding flying leads to pads of a board,
comprising the steps of:
positioning the flying leads to correspond to the pads arranged parallel; and
applying supersonic vibrations to a bonding tool so as to respectively bond the flying leads to the pads,
wherein one side face of each flying lead, which is pressed by the bonding tool, is coated with an insulating layer, and
supersonic vibrations are applied to the bonding tool, which is pressing the flying leads onto the pads through the insulating layers, so that the flying leads are respectively supersonic-bonded to the pads.

3. A method of bonding flying leads to pads of a board,
comprising the steps of:
positioning the flying leads to correspond to the pads arranged parallel; and
applying supersonic vibrations to a bonding tool so as to respectively bond the flying leads to the pads,
wherein an end section of each flying lead is folded in the thickness direction, and
supersonic vibrations are applied to the bonding tool, which is pressing the folded flying leads, in the thickness direction, onto the pads, so that the flying leads are respectively supersonic-bonded to the pads.

4. A method of bonding flying leads to pads of a board,
comprising the steps of:
positioning the flying leads to correspond to the pads arranged parallel; and
applying supersonic vibrations to a bonding tool so as to respectively bond the flying leads to the pads,
wherein each flying lead is coated with a plated layer and has an elliptic cross-sectional shape, and
supersonic vibrations are applied to the bonding tool, which is pressing the flying leads onto the pads, so that the flying leads are respectively supersonic-bonded to the pads.
